(19) United States
(12) Patent Application Publication
(10) Pub. No.: US 2011/0192539 A1
(43) Pub. Date: Aug. 11, 2011

(54) COMPOUND AND METHOD FOR ENHANCING THE FLAME RETARDANT PROPERTIES OF MATERIAL

(76) Inventor: Charles T. Chick, Pleasant Hill, MO (US)

(21) Appl. No.: 12/702,496

(22) Filed: Feb. 9, 2010

(51) Int. Cl. C09D 5/18; B29C 65/00

(52) U.S. Cl. 156/304.1; 106/18.12

(57) ABSTRACT

The disclosure depicts a unique chemical solution and a method of using the same. The solution includes a sodium silicate compound, talc, clay, water, perlite and titanium dioxide in properly measured proportions. Typically, the invention will be used to treat building materials so that the fire retardant or flame resistive properties of a finished product (building or structure) will be enhanced.

### SUMMARY OF THE INVENTION

The invention is a unique compound and a unique method for enhancing the heat resistant qualities of common building materials; the invention also reduces mildew and moisture damage that building materials may face, especially in metal or wood stud wall construction.

The Inventive Composition

The inventive combination is a fire retardant composition. It will include a sodium silicate compound, talc, clay, perlite, titanium dioxide, and water. Preferably, the ingredients will be proportioned to include (by volume) about 60% of the sodium silicate compound, about 12% talc, about 10% clay, about 5% of perlite, about 5% titanium dioxide, and about 10% water.

Experimentation with the ingredients has found that the following proportions yield very good flame-retardant and flame-resistive qualities:

62.55% of N-Sodium Silicate;

12.5% of Talc;

9.4% clay;

9.4% water;

5% perlite;

5% Titanium Dioxide

In a preferred embodiment, the sodium silicate compound is at least one of an N-sodium silicate compound, such as Na₂SiO₃, sodium orthosilicate (Na₄SiO₄) or sodium pyrosilicate (Na₆Si₂O₇).

In this form, the composition is a solution that bears the appearance and general fluid consistency of standard paint that can be applied to a selected surface to enhance the flame retardant qualities of the selected area. In another embodiment, talc may be added to the solution to create a thick, putty-like substance that can be used like a seam or crack filler. In this embodiment, the composition will comprise solution and talc in approximately a 2:1 ratio, by volume.

The Inventive Method

The invention also includes a unique method of treating a selected area, surface, or material to enhance its flame retardant properties. The inventive method includes the steps of providing ingredients of N-sodium silicate, talc, clay, perlite, and titanium dioxide; then combining the ingredients, and adding water to form a solution. Preferably, the solution will have the appearance, viscosity, and general characteristics of standard primer or paint. In that regard, the method includes the step of applying the solution to the selected area that one desires to enhance the flame resistance of.

In a preferred embodiment, the solution will include the ingredients in the following proportions, by volume:

about 60% of a sodium silicate compound;

about 12% talc;

about 10% clay;

about 10% of water;

about 5% of perlite; and

about 5% of titanium dioxide.

When properly mixed, the ingredients above form a solution that bears a consistency and viscosity of standard paint or primer that can be applied to a surface (wood, plaster, magnesium oxide board) with a typical paintbrush. Of course, the inventive solution may also be spray-applied in a known manner.

The inventive method may also include the step of creating a putty by combining the solution with talc. In this embodiment, the putty is formed by combining the solution and talc together in a 2:1 ratio by volume.

The resultant putty can be applied to joints or cracks in material in a manner similar to typical seam-fill, such as by trowel or putty knife or the like. In that regard, the method may include the steps of providing a plurality of boards, each having at least one edge, and positioning the boards such that respective edges are adjacent one another to create at least one seam. Additionally, this method may also include the steps of applying solution to surfaces of the boards, and also applying putty on the seams.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a perspective view of the ingredients used to form a solution, according to the principles of the invention.

FIG. 2 shows the invention in combination with standard applicator apparatus.

FIG. 3 shows the creation of an inventive fire retardant seam-fill paste, according to the principles of the invention.

FIG. 4 shows a perspective view of the invention as used in combination with building materials.

### DETAILED DESCRIPTION OF THE PREFERRED EMBODIMENTS

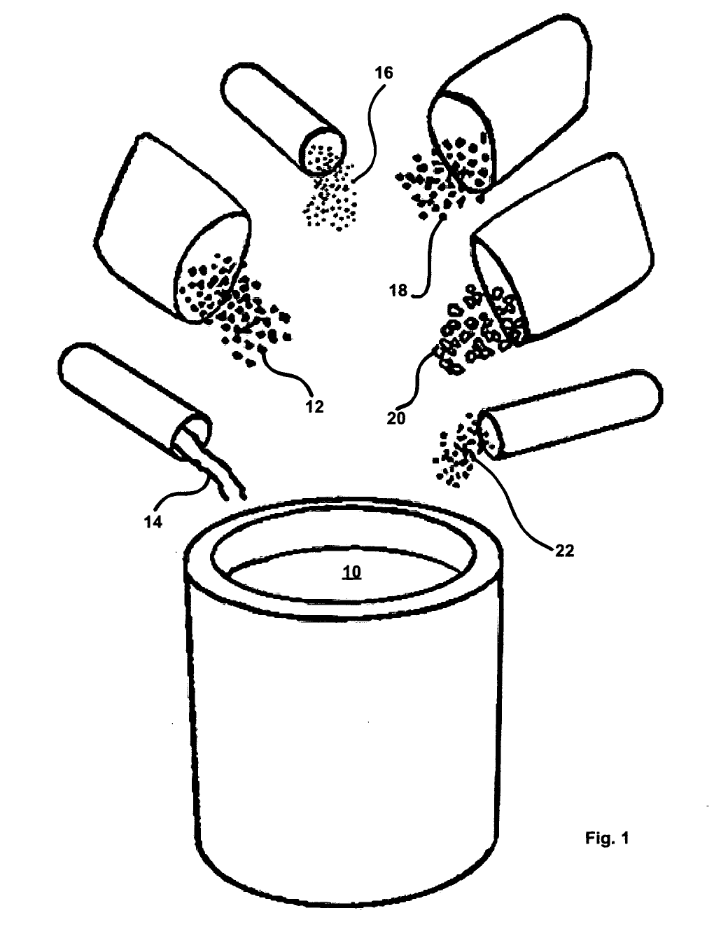

FIG. 1 shows a perspective view that details how the ingredients form an inventive solution 10. The solution 10 will include N-Sodium Silicate 12, talc 16, titanium dioxide 18, clay 20, and perlite 22, and water 14. Preferably, the solution 10 includes about 60% of the N-sodium silicate compound, by volume. By volume, the solution 10 will include about 12% talc 16, about 10% clay 20, about 10% of water, about 5% of perlite; and about 5% of titanium dioxide 18.

Once all of the ingredients of the solution 10, are combined, the matter is stirred until it forms a generally homogeneous liquid that will bear the consistency and general viscosity of a typical paint or primer. It has been found that a high-shear stir or agitation process works well to ascertain that the ingredients combine to form a homogenous solution. Also, as with many paints or primers, some settling of contents may occur after the solution remains still for extended periods of time. Consequently, users are advised to subject the solution to a low shear stir before applying the solution to a selected area.

The N-Sodium Silicate 12 shown in FIG. 1 may include a sodium silicate compound, such as such as sodium silicate (Na₂SiO₃), sodium orthosilicate (Na₄SiO₄) or sodium pyrosilicate (Na₆Si₂O₇). Also, the perlite includes a volcanic glass in which concentric fractures impart a distinctive structure. Generally, the distinctive fracture will resemble small spheroids.

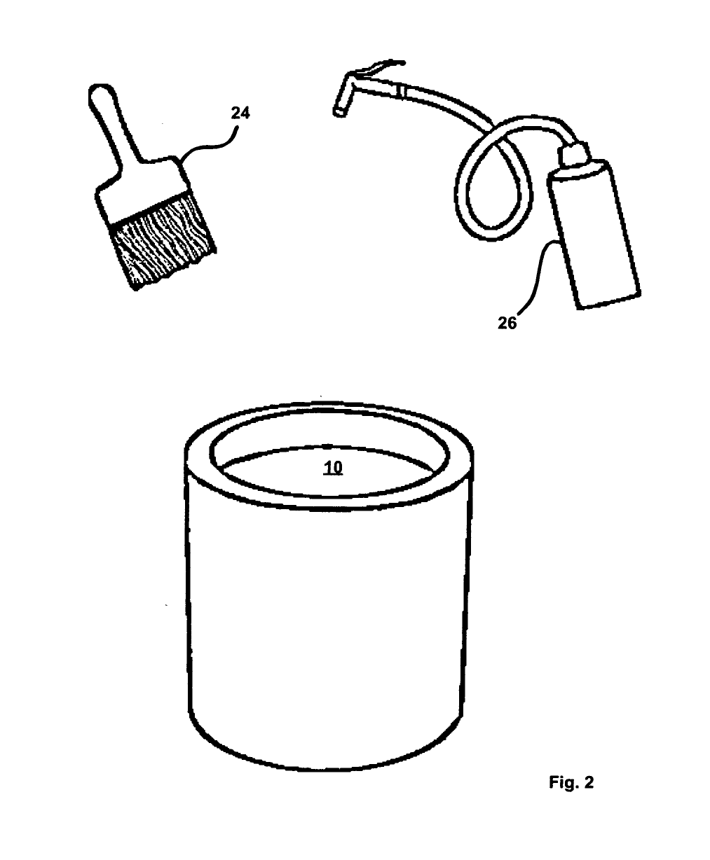

The solution 10 may then be applied (just like a paint) to any selected surface or material that one desires enhanced flame retardance. As shown in FIG. 2, the Solution 10 works well with any known apparatus, such as paintbrushes 24, paint sprayers 26, paint rollers or the like.

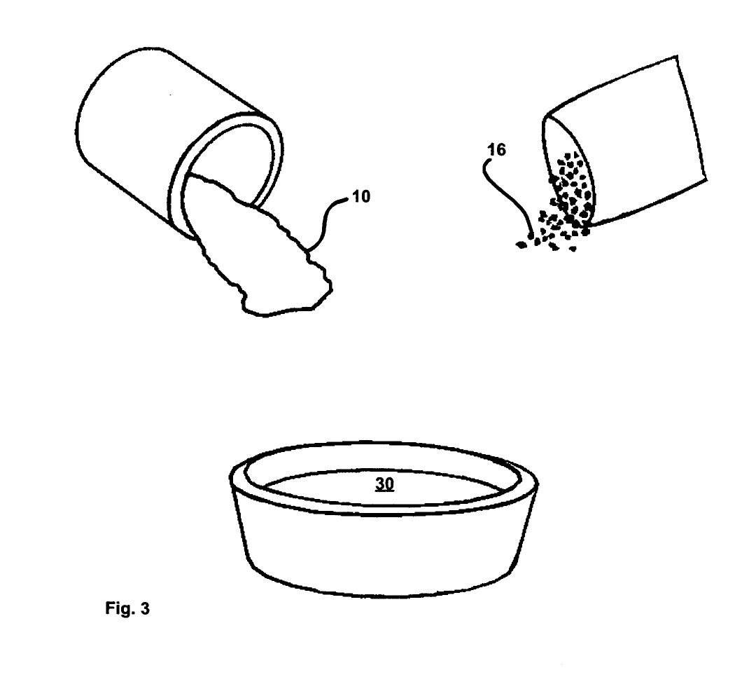

FIG. 3 shows a perspective view of the creation of a seam-fill paste 30. The invention will also include an inventive paste 30 that may be formed by supplementing the solution 10 with additional talc 16 to thicken the solution into a malleable, spreadable seam-fill material that will dry hard, much like standard seam-fill or plaster. For best results, the paste 30 is formed by combining two parts of solution 10 with one part talc 16; hence, the ratio (by volume) of solution 10 to talc 16 is 2:1. Once the seam-fill paste 30 hardens and cures to a surface, it may be sanded or smoothed as needed.

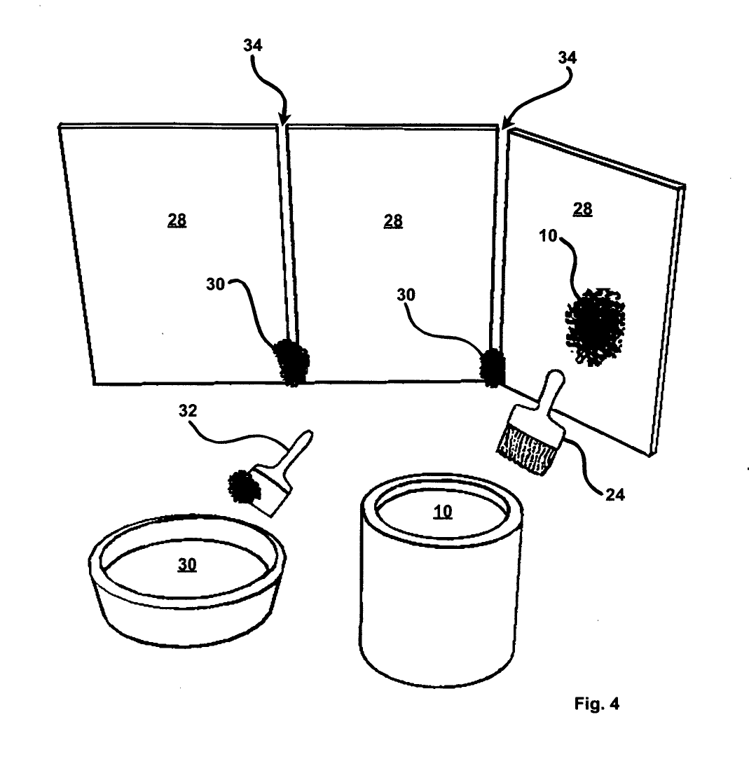

FIG. 4 shows the solution 10 and paste 30 as it may be applied to building materials 28. The building materials 28 are shown to be standard dry-wall panels such as magnesium oxide panels, but it is to be understood that the inventive solution 10 and paste 30 each work well with any known building material (such as wood, plastic, sheet rock, or the like) to enhance fire protection. One may use a trowel 32 or a putty-knife or any known applicator to smooth daleps of paste 30 into the seams or spaces 34 between boards or panels 28. Once the seam-fill paste 30 hardens and cures to a surface, it may be sanded or smoothed as needed.

Still referring to FIG. 4, the surfaces of panels 28 may be treated with solution 10 by using a paintbrush 24 (or other known applicator, such as a sprayer or roller for example) so that the solution 10′ covers a selected area of a face of the board or panel 28.

Although the present invention has been described and illustrated in detail, it is to be clearly understood that the same is by way of illustration and example only, and is not to be taken by way of limitation. The spirit and scope of the present invention are to be limited only by the appended claims that precisely define the metes and bounds of the invention.

I claim:

1. A fire retardant composition, comprising:
sodium silicate;
talc,
clay,
water,
perlite,
titanium dioxide.

2. The composition as in claim 1, wherein the composition includes
ingredients with the following proportions, by volume:
about 60% of a sodium silicate compound;
about 12% talc;
about 10% clay;
about 10% of water;
about 5% of perlite; and
about 5% of titanium dioxide.

3. The composition as in claim 2, wherein the sodium silicate compound is at least one of an N-sodium silicate compound.

4. The composition as in claim 2, wherein the sodium silicate compound includes Na₂SiO₃.

5. The composition as in claim 2, wherein the sodium silicate compound includes one of sodium orthosilicate (Na₄SiO₄) or sodium pyrosilicate (Na₆Si₂O₇).

6. The composition as in claim 1, wherein the composition includes
ingredients in the following approximate proportions, by volume:
66.55% of N-Sodium Silicate; 12.5% of Talc, 9.4% clay, 9.4% water, 5% Perlite, 5% Titanium Dioxide.

7. A method of treating a selected area comprising the steps of:
providing ingredients of N-sodium silicate, talc, clay, perlite, and titanium dioxide;
combining the ingredients;
adding water to form a solution.

8. The method as in claim 7, further including the steps of
applying the solution to a selected area.

9. The method as in claim 7, further comprising the step of combining the ingredients with the following proportions, by volume:
about 60% of a sodium silicate compound;
about 12% talc;
about 10% clay;
about 10% of water;
about 5% of perlite; and
about 5% of titanium dioxide.

9. The method of claim 7, further comprising the step of
creating a paste by combining the solution with talc.

10. The method as in claim 9, the step of creating a paste including the step of ascertaining that the paste includes solution and talc in approximately a 2:1 ratio, by volume.

11. The method as in claim 9, further including the step of applying the paste to a selected area.

12. The method as in claim 10, further including the steps of
providing a plurality of boards, each having at least one edge
positioning the boards such that respective edges are adjacent one another to create at least one seam; and,
applying solution to surfaces of the boards;
applying paste on the seams.
